(19) United States
(12) Patent Application Publication
(10) Pub. No.: US 2026/0170579 A1
(43) Pub. Date: Jun. 18, 2026

(54) METHODS AND SYSTEMS FOR FACILITATING MANAGEMENT OF REAL ESTATE TRANSACTIONS

(71) Applicant: Klaviss Technologies Corporation, Yorba Linda, CA (US)

(72) Inventors: Seth Paul Bradley, Oceanside, CA (US); Amrindra Flora, San Mateo, CA (US); David Amaral, Orange, CA (US); Jacob Mauricio Repreza, Chino Hills, CA (US); Omid Yousofi, Costa Mesa, CA (US)

(21) Appl. No.: 19/425,653

(22) Filed: Dec. 18, 2025

Related U.S. Application Data
(60) Provisional application No. 63/735,707, filed on Dec. 18, 2024.

(51) Int. Cl. G06Q 50/163

(52) U.S. Cl. CPC G06Q 50/163

(57) ABSTRACT

The present disclosure provides a method for facilitating management of real estate transactions. Further, the method may include receiving a document data representing one or more real estate documents associated with one or more real estate transactions from one or more first entity devices. Further, the method may include receiving a task data representing one or more tasks associated with the one or more real estate documents. Further, the method may include analyzing each of the document data and the task data using one or more artificial intelligences (AI) model. Further, the method may include determining a completion status for the one or more real estate transactions using the one or more AI models. Further, the method may include generating a notification data based on the determining of the completion status. Further, the method may include transmitting the notification data to one or more second entity devices.

The current application claims a priority to the U.S. Provisional Patent application Ser. No. 63/735,707 filed on Dec. 18, 2024.

### FIELD OF DISCLOSURE

The present disclosure relates to the field of data processing. More specifically, the present disclosure relates to methods and systems for facilitating management of real estate transactions.

### BACKGROUND

The field of data processing technologies used in transactional environments, including digital platforms that support coordination, documentation, and administrative oversight among multiple parties, is of substantial importance as modern commercial activities increasingly depend on accurate information exchange, timely task completion, and dependable compliance monitoring across electronically interconnected systems. Reliable processing of documents, status updates, and procedural records is essential to ensure that complex multi-party transactions proceed efficiently, securely, and without unnecessary delays.

An objective that is desirable in the given field is to enable seamless, accurate, and real-time management of tasks, documents, communications, and compliance activities across all participants involved in a transaction. Such an objective includes the ability to ensure that critical information contained in submitted documents is correctly interpreted, that each participant is notified of relevant obligations at appropriate times, and that compliance with procedural or regulatory requirements is consistently verified throughout the lifecycle of a transaction.

However, existing systems, platforms, and manual methods for managing multi-party transactions face several challenges in achieving the said objective. In many instances, documents submitted by different parties may vary widely in structure, format, or quality, increasing the difficulty for traditional systems to extract the necessary information reliably. Communication channels may not synchronize well with task dependencies, causing delays or missed steps in the progression of a transaction. Furthermore, ensuring that each procedural or compliance requirement has been satisfied often involves significant manual review, which may introduce inconsistencies, oversights, or processing inefficiencies. The said challenges may be compounded when transactions involve large volumes of documents, multiple regulatory or procedural rules, or parties using diverse devices and submission practices. As a result, transaction pipelines may experience operational bottlenecks, lack of visibility into real-time status, and uncertainty regarding whether submitted materials satisfy applicable requirements.

Therefore, there is a need for improved methods and systems for facilitating management of real estate transactions that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for facilitating management of real estate transactions. Further, the method may include receiving, using a communication device, a document data from one or more first entity devices associated with one or more first entities. Further, the document data represents one or more real estate documents associated with one or more real estate transactions. Further, the method may include receiving, using the communication device, a task data from the one or more first entity devices. Further, the task data represents one or more tasks associated with the one or more real estate document relatives to the one or more real estate transactions. Further, the method may include analyzing, using a processing device, each of the document data and the task data using one or more artificial intelligence (AI) models. Further, the method may include determining, using the processing device, a completion status for the one or more real estate transactions using the one or more AI models based on the analyzing of each of the document data and the task data. Further, the method may include generating, using the processing device, a notification data based on the determining of the completion status. Further, the notification data represents one or more notifications informing one or more second entities of completion status. Further, the method may include transmitting, using the communication device, the notification data to one or more second entity devices associated with the one or more second entities.

The present disclosure provides a system for facilitating management of real estate transactions. Further, the system may include a communication device. Further, the communication device may be configured for receiving a document data from one or more first entity devices associated with one or more first entities. Further, the document data represents one or more real estate documents associated with one or more real estate transactions. Further, the communication device may be configured for receiving a task data from the one or more first entity devices. Further, the task data represents one or more tasks associated with the one or more real estate document relatives to the one or more real estate transactions. Further, the communication device may be configured for transmitting a notification data to one or more second entity devices associated with one or more second entities. Further, the system may include a processing device communicatively coupled with the communication device. Further, the processing device may be configured for analyzing each of the document data and the task data using one or more artificial intelligence (AI) models. Further, the processing device may be configured for determining a completion status for the one or more real estate transactions using the one or more AI models based on the analyzing of each of the document data and the task data. Further, the processing device may be configured for generating the notification data based on the determining of the completion status. Further, the notification data represents one or more notifications informing the one or more second entities of completion status.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating management of real estate transactions, in accordance with some embodiments.

FIG. 4 illustrates a flowchart of a method 400 for facilitating management of real estate transactions including analyzing, using the processing device 1004, the regulatory data using the at least one AI model, in accordance with some embodiments.

FIG. 5 illustrates a flowchart of a method 500 for facilitating management of real estate transactions including receiving, using the communication device 1002, the regulatory data from the at least one regulatory database device, in accordance with some embodiments.

FIG. 6 illustrates a flowchart of a method 600 for facilitating management of real estate transactions including identifying, using the processing device 1004, the at least one regulatory body associated with the at least one jurisdiction, in accordance with some embodiments.

FIG. 7 illustrates a flowchart of a method 700 for facilitating management of real estate transactions including generating, using the processing device 1004, an upcoming task data using the third AI model, in accordance with some embodiments.

FIG. 8 illustrates a flowchart of a method 800 for facilitating management of real estate transactions including determining, using the processing device 1004, a valuation for the at least one real estate property, in accordance with some embodiments.

FIG. 9 illustrates a flowchart of a method 900 for facilitating management of real estate transactions including generating, using the processing device 1004, an assessment report for the at least one real estate property using the fifth AI model, in accordance with some embodiments.

FIG. 10 illustrates a block diagram of a system 1000 for facilitating management of real estate transactions, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating the management of real estate transactions using artificial intelligence. Further, the disclosed system may use AI (OCR-LLM) to scan and extract information from all real estate documents, automate tasks, etc. Essentially, the disclosed system automates, systematizes, and codifies the logic of the real estate process in a manner similar to how a human real estate agent would carry out tasks. Further, the disclosed system may facilitate the tasks of a compliance officer by building further logic and innovation with AI (OCR-LLM). So, whenever any party in a real estate transaction using the disclosed system, completes a task by executing the relevant documents (for example, remove an inspection contingency), the task/document may automatically be matched in a compliance tab of the disclosed system using AI which is reading the document name, checked boxes, signatures, names, property address, etc.

In some embodiments, the disclosed system may introduce an inherent technical improvement by employing multimodal artificial intelligence models, including hybrid OCR-LLM architectures, to automatically extract structured real estate information from heterogeneous, semi-structured, and unstructured documents. The underlying technical problem arises from the inability of conventional OCR or rule-based systems to reliably infer meaning from diverse contract formats, checkboxes, signatures, initials, and transaction-specific terms, which typically vary across jurisdictions and brokers. In some embodiments, the system may combine vision-transformer-based OCR pipelines with large-language-model reasoning layers that may jointly reason over spatial layout, semantic context, and regulatory constraints. In some embodiments, the system may implement the said aspect using transformer-based sequence-to-sequence models operating on document image embeddings, or using a two-stage model in which a neural layout parser may convert raw pixels into spatial tokens, after which an LLM may generate normalized output fields. In some embodiments, the technical improvement may enhance the underlying technology of automated document understanding and compliance-ready data extraction in enterprise transaction-processing systems.

In some embodiments, the system may provide a second inherent technical improvement by automatically determining the real-time status of a real estate transaction using state-machine logic encoded within machine-learning-derived semantic graphs. The technical problem addressed is that conventional workflow tracking systems rely on manually updated checklists that are error-prone, asynchronous, and incapable of dynamically re-computing required successor tasks based on nuanced contractual dependencies. In some embodiments, the system may generate a transaction-state graph using neural symbolic reasoning, where extracted document features may be mapped to predefined transactional nodes; successor edges may be automatically activated based on confidence thresholds derived from model inference. In some embodiments, the system may implement dynamic re-computation of state using Bayesian graph updates, reinforcement-learning-derived policy evaluation, or LLM-powered constraint verification. The technical improvement thereby enhances workflow automation technology by enabling autonomous, self-correcting state progression.

In some embodiments, an inherent technical improvement may arise from the system's ability to match newly submitted documents to compliance requirements using intelligent document-behavior classification. The technical problem addressed is that traditional systems may not autonomously determine whether an uploaded document fulfills specific compliance tasks, because document titles, signatures, and checkbox selections vary widely. In some embodiments, the system may embed documents into high-dimensional representation spaces using contrastively trained encoders, after which a classifier may compute similarity between the document's latent vector and the latent vector of a regulatory requirement. In some embodiments, matching may incorporate signature-verification submodules, layout-based voting, or cross-document entailment models to determine whether the content satisfies statutory disclosure or contingency-removal requirements. The relevant improved technology is intelligent compliance automation for regulated workflow systems.

In some embodiments, an additional inherent technical improvement may be provided by allowing the system to generate automated notifications based on AI-derived interpretations of document meaning rather than based solely on user-input triggers. The underlying technical problem is that conventional notification systems may not reliably determine when a downstream party must act, because such systems lack semantic understanding of contractual triggers such as contingency expiration or partial task fulfillment. In some embodiments, the system may use temporal-event extraction models to parse critical dates, contractual milestones, and deadline clauses; the system may feed the extracted temporal graph into a scheduler that may compute successor tasks and notification times. In some embodiments, the system may employ LLM-based temporal reasoning, machine-learning-based date normalization, or transformer-based legal-clause interpretation. The improved technology is intelligent event-driven communication in transactional automation platforms.

In some embodiments, the disclosed system may include an inherent technical improvement by incorporating adaptive compliance-verification models that may learn from historical error patterns, thereby enabling continuous improvement without manual rule authoring. The technical problem is that compliance rules vary by county, lender, brokerage, and timeframe, and traditional static rule engines may not adapt quickly. In some embodiments, the system may maintain a feedback dataset where improperly completed tasks, missing signatures, or inconsistent addresses may be labeled by human compliance officers; subsequently, a supervised or self-supervised model may update internal parameters to improve future detection accuracy. In some embodiments, the system may implement federated learning, where compliance patterns from different offices may contribute to a unified model without sharing raw documents. The technical improvement enhances adaptive regulatory-compliance-automation systems.

In some embodiments, the system may inherently improve the technology for multi-party real estate transaction coordination by enabling near real-time ingestion of scanned documents through continuous streaming OCR pipelines. The technical problem is that real estate parties often use disparate devices, and document submission may occur at unpredictable times; traditional batch-processing OCR systems may not provide immediate status updates. In some embodiments, the system may integrate incremental OCR decoding-such as streaming transformers—where partial page images may yield partial text extractions that may trigger early compliance predictions. In some embodiments, the system may apply asynchronous event-driven micro services, serverless compute layers, or distributed GPU inference clusters for immediate analysis. The technology improved is a real-time document-analysis infrastructure.

In some embodiments, another inherent technical improvement may arise from implementing document-provenance tracking and digital-audit-trail generation using AI-detected semantic changes. The technical problem is that standard logging systems only store timestamps but may not capture whether a newly submitted document meaningfully differs from a prior submission. In some embodiments, the system may generate semantic diffs using transformer-based cross-document comparison, embedding-similarity delta checks, or structural layout changes. In some embodiments, the system may compute a reliability index that may indicate whether a new submission should be treated as a correction, a supplement, or an entirely new document class. The improved technology is intelligent provenance tracking in regulated document-processing environments.

In some embodiments, the system may be enhanced with an additional technical improvement by integrating a zero-knowledge verification subsystem, allowing specific compliance verifications to be proven without revealing full document contents. The technical problem is that privacy and legal restrictions often prevent full document sharing, yet verification of compliance elements (such as signature presence or checkbox selection) may still be required. In some embodiments, the system may implement zk-SNARK-based document-feature proofs; in other embodiments, the system may use cryptographic commitments or homomorphic hashing. The improved technology is privacy-preserving compliance automation.

In some embodiments, an additional technical improvement may be achieved by incorporating a cross-jurisdictional regulatory-reasoning layer that may automatically adjust compliance requirements based on geolocation and document metadata. The technical problem is that compliance rules differ by state, county, MLS system, or institutional lender, and traditional systems require manual configuration. In some embodiments, the system may use a regulatory-knowledge graph trained with LLM-generated embeddings of regional statutes; in some instances, the system may automatically infer jurisdiction using address extraction, escrow documents, or geotagged submissions. The improved technology is automated regulatory-context adaptation for transactional systems.

In some embodiments, the system may further include a predictive-task-forecasting engine that may estimate future required documents and deadlines before the transaction reaches later stages. The technical problem is that delays often arise because parties are unaware of upcoming requirements, and conventional systems lack forecasting capabilities. In some embodiments, predictive models may use historical transaction corpora to compute probability distributions of future steps; the system may generate proactive alerts if a high-likelihood future requirement is at risk. In some embodiments, transformer-based time-series models, survival-analysis algorithms, or causal inference engines may be used. The improved technology is predictive workflow orchestration.

In some embodiments, the system may provide an additional technical improvement by generating AI-assisted corrective drafts when a submitted document is partially non-compliant. The technical problem is that human users often submit incomplete or improperly filled forms, and traditional systems merely reject them without guidance. In some embodiments, the system may use generative models to propose corrected versions, highlight missing fields, or generate suggested addenda. In some embodiments, multimodal editing models may modify document layouts, re-generate pages, or produce compliant signature blocks. The improved technology is automated corrective-document generation.

In some embodiments, an additional technical improvement may include employing blockchain-based smart-contract execution to automate escrow-triggered events based on validated compliance states. The technical problem is that escrow workflows rely on manual verification before releasing funds or progressing to closing, which introduces inefficiency and risk. In some embodiments, the system may encode compliance states as oracles feeding into smart contracts; the blockchain network may automatically perform fund release, access-permission updates, or milestone acknowledgments once the AI system provides validated proofs of task completion. The improved technology is a secure, autonomous transaction-settlement infrastructure.

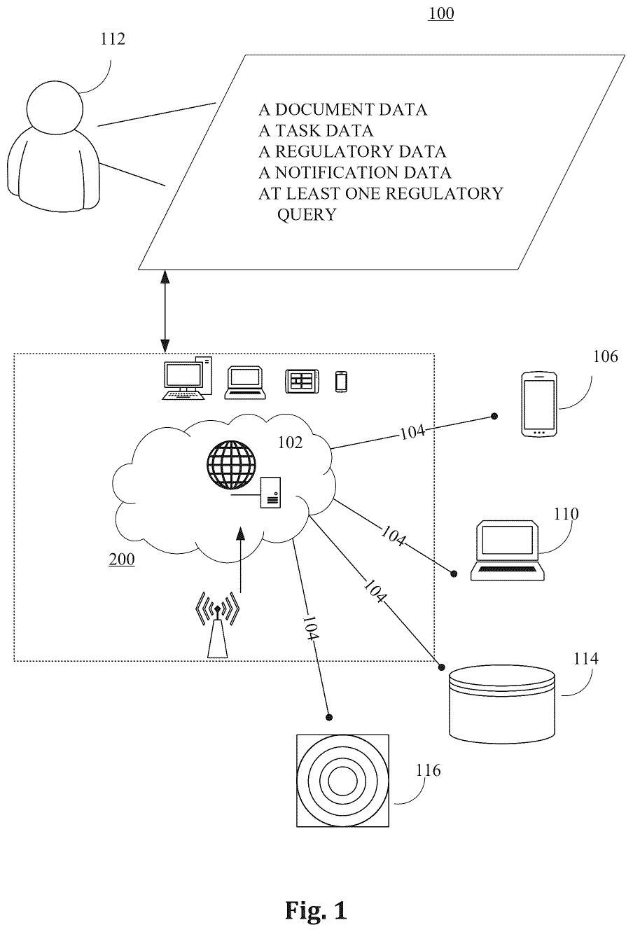

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

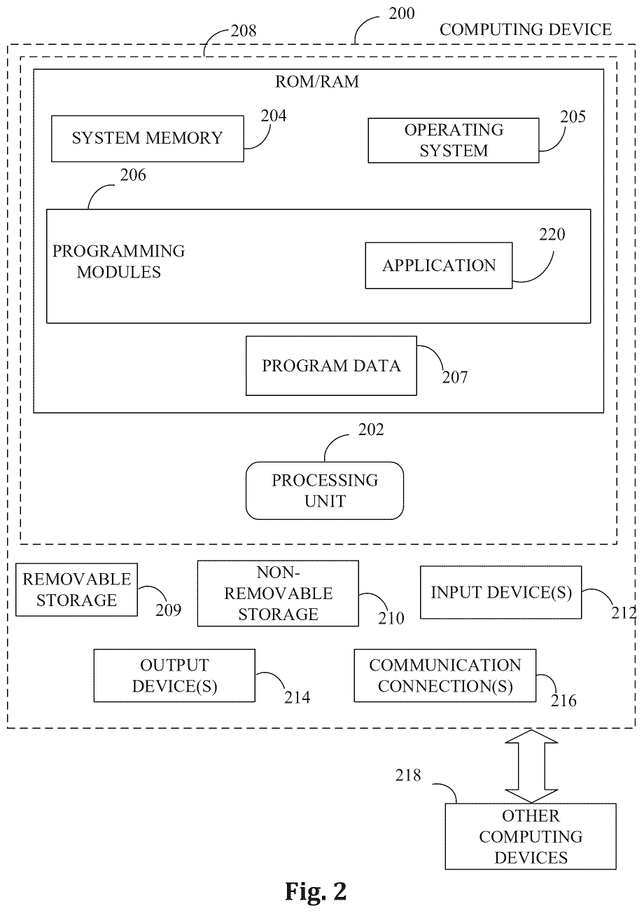

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

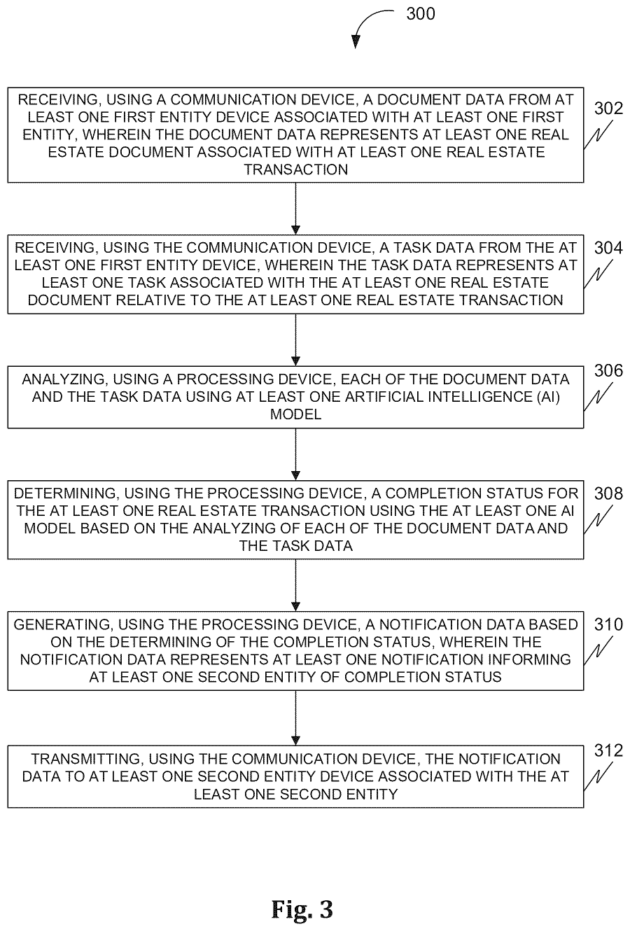

FIG. 3 illustrates a flowchart of a method 300 for facilitating management of real estate transactions, in accordance with some embodiments. Accordingly, the method 300 may include a step 302 of receiving, using a communication device 1002, a document data from one or more first entity devices associated with one or more first entities. Further, the document data represents one or more real estate documents associated with one or more real estate transactions. Further, the method 300 may include a step 304 of receiving, using the communication device 1002, a task data from the one or more first entity devices. Further, the task data represents one or more tasks associated with the one or more real estate document relatives to the one or more real estate transactions. Further, the method 300 may include a step 306 of analyzing, using a processing device 1004, each of the document data and the task data using one or more artificial intelligence (AI) models. Further, the method 300 may include a step 308 of determining, using the processing device 1004, a completion status for the one or more real estate transactions using the one or more AI models based on the analyzing of each of the document data and the task data. Further, the method 300 may include a step 310 of generating, using the processing device 1004, a notification data based on the determining of the completion status. Further, the notification data represents one or more notifications informing one or more second entities of completion status. Further, the method 300 may include a step 312 of transmitting, using the communication device 1002, the notification data to one or more second entity devices associated with the one or more second entities.

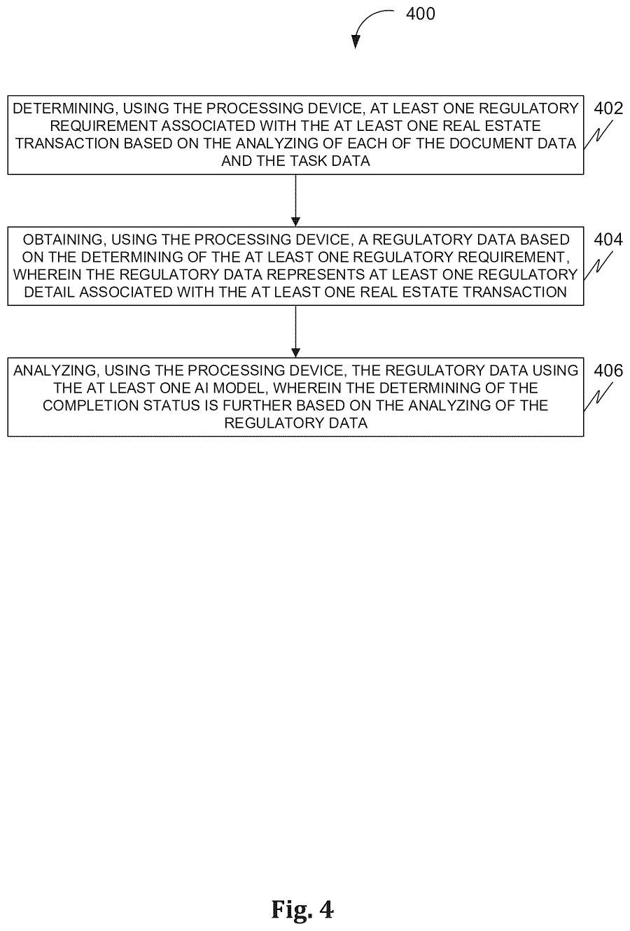

FIG. 4 illustrates a flowchart of a method 400 for facilitating management of real estate transactions including analyzing, using the processing device 1004, the regulatory data using the at least one AI model, in accordance with some embodiments. Further, in some embodiments, the method 400 further may include a step 402 of determining, using the processing device 1004, one or more regulatory requirements associated with the one or more real estate transactions based on the analyzing of each of the document data and the task data. Further, in some embodiments, the method 400 further may include a step 404 of obtaining, using the processing device 1004, a regulatory data based on the determining of the one or more regulatory requirements. Further, the regulatory data represents one or more regulatory details associated with the one or more real estate transactions. Further, in some embodiments, the method 400 further may include a step 406 of analyzing, using the processing device 1004, the regulatory data using the one or more AI models. Further, the determining of the completion status may be further based on the analyzing of the regulatory data.

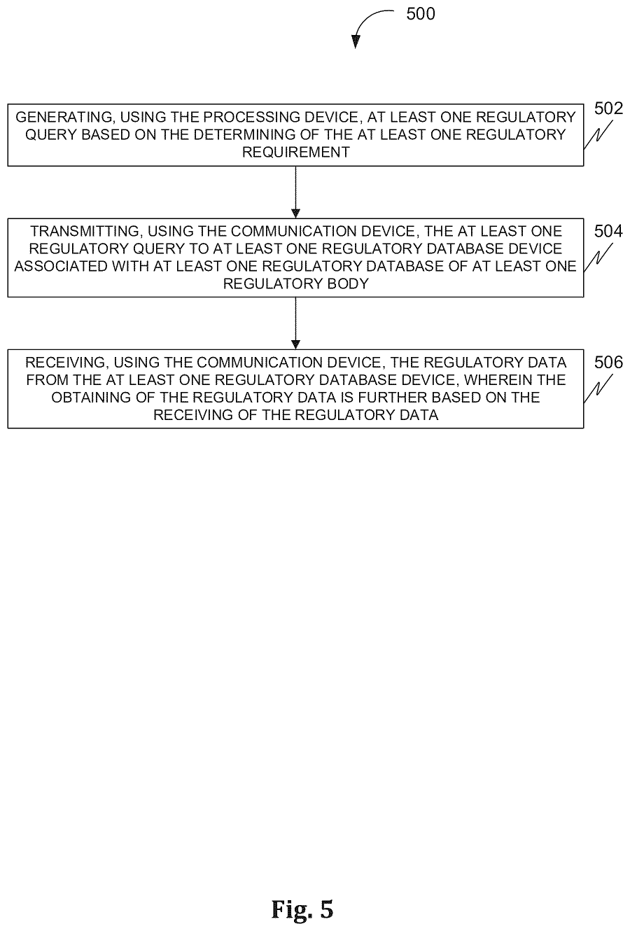

FIG. 5 illustrates a flowchart of a method 500 for facilitating management of real estate transactions including receiving, using the communication device 1002, the regulatory data from the at least one regulatory database device, in accordance with some embodiments. Further, in some embodiments, the method 500 further may include a step 502 of generating, using the processing device 1004, one or more regulatory queries based on the determining of the one or more regulatory requirements. Further, in some embodiments, the method 500 further may include a step 504 of transmitting, using the communication device 1002, the one or more regulatory queries to one or more regulatory database devices associated with one or more regulatory databases of one or more regulatory bodies. Further, in some embodiments, the method 500 further may include a step 506 of receiving, using the communication device 1002, the regulatory data from the one or more regulatory database devices. Further, the obtaining of the regulatory data may be further based on the receiving of the regulatory data.

In some embodiments, the one or more AI models may be an optical character recognition-enabled large language (OCR-LLM) model.

In some embodiments, the method 300 may further include verifying, using the processing device 1004, the one or more real estate documents using a zero-knowledge proof. Further, the zero-knowledge proof enables a validation of one or more of an authenticity and an integrity of the one or more real estate documents without revealing one or more contents of the one or more real estate documents. Further, the analyzing of each of the document data and the task data may be further based on the verifying of the one or more real estate documents.

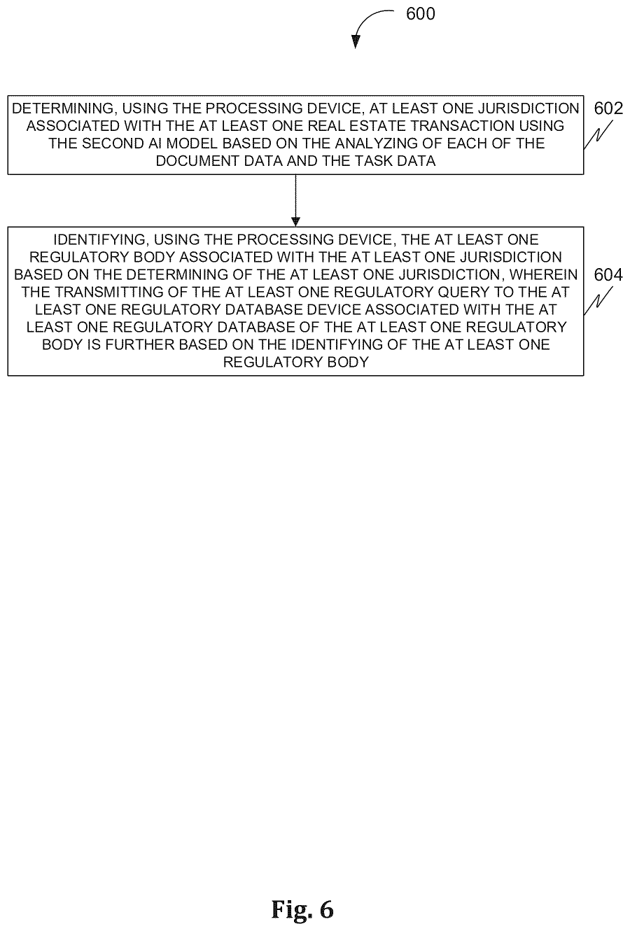

FIG. 6 illustrates a flowchart of a method 600 for facilitating management of real estate transactions including identifying, using the processing device 1004, the at least one regulatory body associated with the at least one jurisdiction, in accordance with some embodiments. Further, in some embodiments, the one or more AI models may include a second artificial intelligence (AI) model. Further, the method 600 further may include a step 602 of determining, using the processing device 1004, one or more jurisdictions associated with the one or more real estate transactions using the second AI model based on the analyzing of each of the document data and the task data. Further, the method 600 further may include a step 604 of identifying, using the processing device 1004, the one or more regulatory bodies associated with the one or more jurisdictions based on the determining of the one or more jurisdictions. Further, the transmitting of the one or more regulatory queries to the one or more regulatory database devices associated with the one or more regulatory databases of the one or more regulatory bodies may be further based on the identifying of the one or more regulatory bodies.

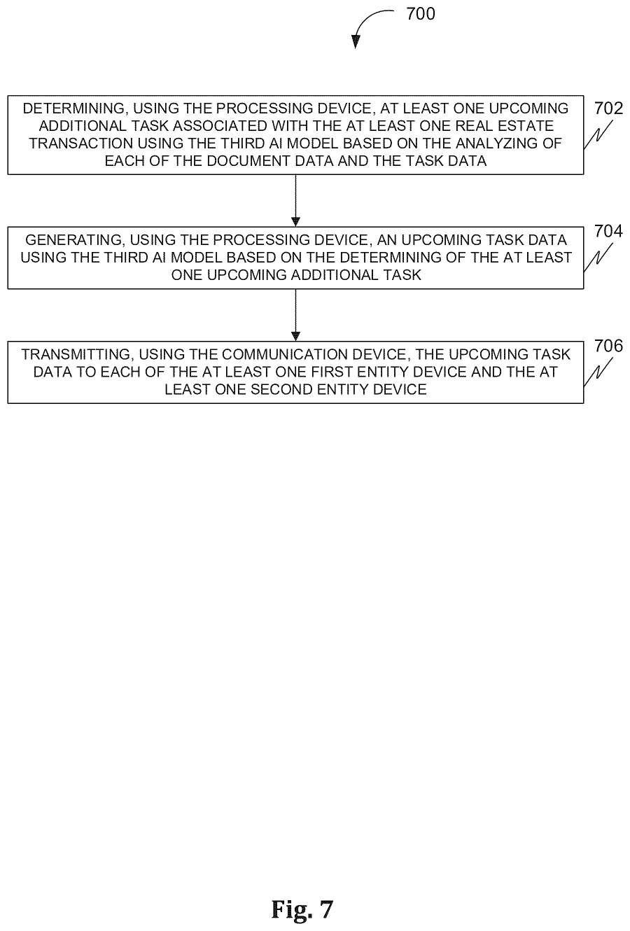

FIG. 7 illustrates a flowchart of a method 700 for facilitating management of real estate transactions including generating, using the processing device 1004, an upcoming task data using the third AI model, in accordance with some embodiments. Further, in some embodiments, the one or more AI models further may include a third artificial intelligence (AI) model. Further, the method 700 further may include a step 702 of determining, using the processing device 1004, one or more upcoming additional tasks associated with the one or more real estate transactions using the third AI model based on the analyzing of each of the document data and the task data. Further, the method 700 further may include a step 704 of generating, using the processing device 1004, an upcoming task data using the third AI model based on the determining of the one or more upcoming additional tasks. Further, the method 700 further may include a step 706 of transmitting, using the communication device 1002, the upcoming task data to each of the one or more first entity devices and the one or more second entity devices.

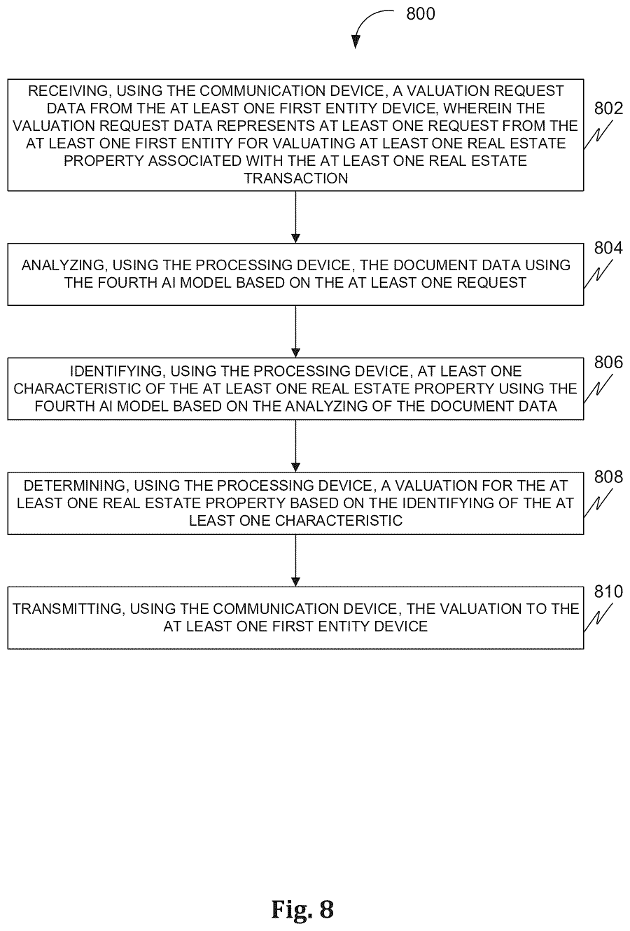

FIG. 8 illustrates a flowchart of a method 800 for facilitating management of real estate transactions including determining, using the processing device 1004, a valuation for the at least one real estate property, in accordance with some embodiments. Further, in some embodiments, the one or more AI models further may include a fourth artificial intelligence (AI) model. Further, the method 800 further may include a step 802 of receiving, using the communication device 1002, a valuation request data from the one or more first entity devices. Further, the valuation request data represents one or more requests from the one or more first entities for valuating one or more real estate properties associated with the one or more real estate transactions. Further, the method 800 further may include a step 804 of analyzing, using the processing device 1004, the document data using the fourth AI model based on the one or more requests. Further, the method 800 further may include a step 806 of identifying, using the processing device 1004, one or more characteristics of the one or more real estate properties using the fourth AI model based on the analyzing of the document data. Further, the method 800 further may include a step 808 of determining, using the processing device 1004, a valuation for the one or more real estate properties based on the identifying of the one or more characteristics. Further, the method 800 further may include a step 810 of transmitting, using the communication device 1002, the valuation to the one or more first entity devices.

In some embodiments, the completion status includes one or more of a complete status and an incomplete status. Further, the method 300 further includes generating, using the processing device 1004, a rectification data based on the determining of the completion status, comprising the incomplete status. Further, the rectification data represents one or more rectification details relative to the one or more tasks.

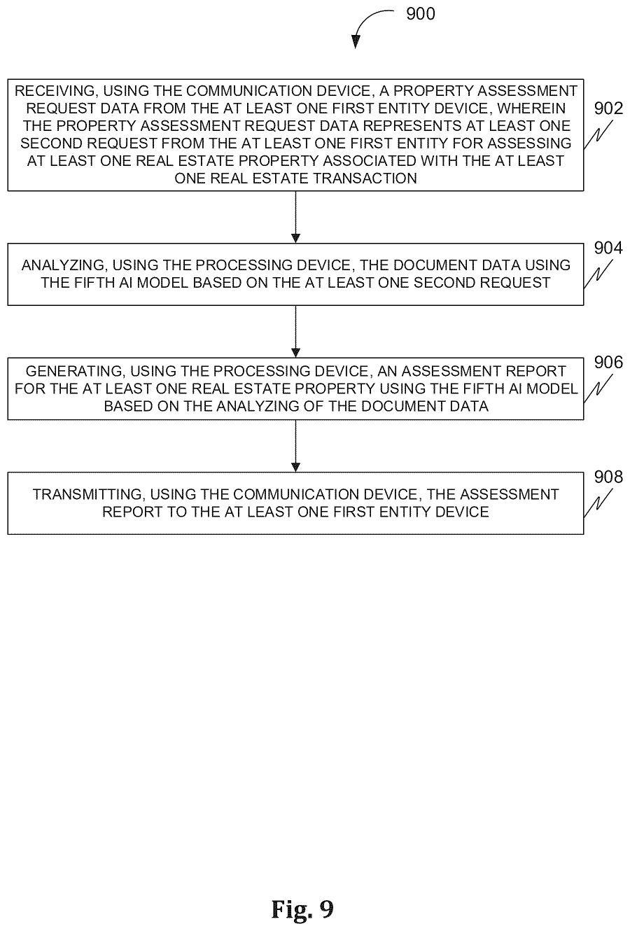

FIG. 9 illustrates a flowchart of a method 900 for facilitating management of real estate transactions including generating, using the processing device 1004, an assessment report for the at least one real estate property using the fifth AI model, in accordance with some embodiments. Further, in some embodiments, the one or more AI models further may include a fifth artificial intelligence (AI) model. Further, the method 900 further may include a step 902 of receiving, using the communication device 1002, a property assessment request data from the one or more first entity devices. Further, the property assessment request data represents one or more second requests from the one or more first entities for assessing one or more real estate properties associated with the one or more real estate transactions. Further, the method 900 further may include a step 904 of analyzing, using the processing device 1004, the document data using the fifth AI model based on the one or more second requests. Further, the method 900 further may include a step 906 of generating, using the processing device 1004, an assessment report for the one or more real estate properties using the fifth AI model based on the analyzing of the document data. Further, the method 900 further may include a step 908 of transmitting, using the communication device 1002, the assessment report to the one or more first entity devices.

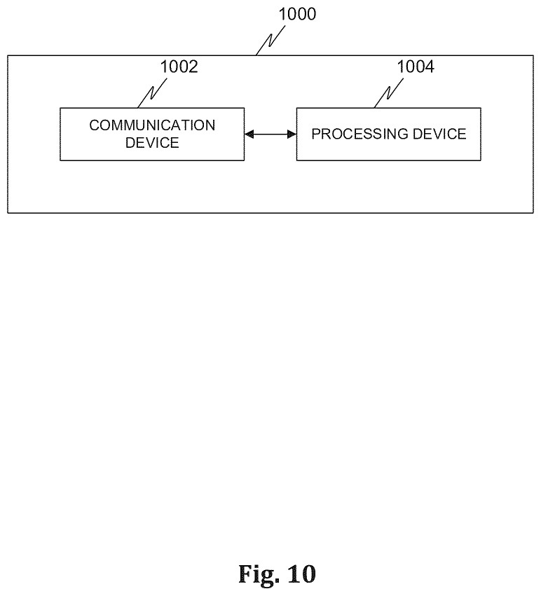

FIG. 10 illustrates a block diagram of a system 1000 for facilitating management of real estate transactions, in accordance with some embodiments. Accordingly, the system 1000 may include a communication device 1002. Further, the communication device 1002 may be configured for receiving a document data from one or more first entity devices associated with one or more first entities. Further, the document data represents one or more real estate documents associated with one or more real estate transactions. Further, the communication device 1002 may be configured for receiving a task data from the one or more first entity devices. Further, the task data represents one or more tasks associated with the one or more real estate document relatives to the one or more real estate transactions. Further, the communication device 1002 may be configured for transmitting a notification data to one or more second entity devices associated with one or more second entities. Further, the system 1000 may include a processing device 1004 communicatively coupled with the communication device 1002. Further, the processing device 1004 may be configured for analyzing each of the document data and the task data using one or more artificial intelligence (AI) models. Further, the processing device 1004 may be configured for determining a completion status for the one or more real estate transactions using the one or more AI models based on the analyzing of each of the document data and the task data. Further, the processing device 1004 may be configured for generating the notification data based on the determining of the completion status. Further, the notification data represents one or more notifications informing the one or more second entities of completion status.

Further, in some embodiments, the processing device 1004 may be further configured for determining one or more regulatory requirements associated with the one or more real estate transactions based on the analyzing of each of the document data and the task data. Further, the processing device 1004 may be further configured for obtaining a regulatory data based on the determining of the one or more regulatory requirements. Further, the regulatory data represents one or more regulatory details associated with the one or more real estate transactions. Further, the processing device 1004 may be further configured for analyzing the regulatory data using the one or more AI models. Further, the determining of the completion status may be further based on the analyzing of the regulatory data.

Further, in some embodiments, the processing device 1004 may be further configured for generating one or more regulatory queries based on the determining of the one or more regulatory requirements. Further, the communication device 1002 may be further configured for transmitting the one or more regulatory queries to one or more regulatory database devices associated with one or more regulatory databases of one or more regulatory bodies. Further, the communication device 1002 may be further configured for receiving the regulatory data from the one or more regulatory database devices. Further, the obtaining of the regulatory data may be further based on the receiving of the regulatory data.

In some embodiments, the one or more AI models may be an optical character recognition-enabled large language (OCR-LLM) model.

In some embodiments, the processing device 1004 may be further configured for verifying the one or more real estate documents using a zero-knowledge proof. Further, the zero-knowledge proof enables a validation of one or more of an authenticity and an integrity of the one or more real estate documents without revealing one or more contents of the one or more real estate documents. Further, the analyzing of each of the document data and the task data may be further based on the verifying of the one or more real estate documents.

Further, in some embodiments, the one or more AI models may include a second artificial intelligence (AI) model. Further, the processing device 1004 may be further configured for determining one or more jurisdictions associated with the one or more real estate transactions using the second AI model based on the analyzing of each of the document data and the task data. Further, the processing device 1004 may be further configured for identifying the one or more regulatory bodies associated with the one or more jurisdictions based on the determining of the one or more jurisdictions. Further, the transmitting of the one or more regulatory queries to the one or more regulatory database devices associated with the one or more regulatory databases of the one or more regulatory bodies may be further based on the identifying of the one or more regulatory bodies.

Further, in some embodiments, the one or more AI models further may include a third artificial intelligence (AI) model. Further, the processing device 1004 may be further configured for determining one or more upcoming additional tasks associated with the one or more real estate transactions using the third AI model based on the analyzing of each of the document data and the task data. Further, the processing device 1004 may be further configured for generating an upcoming task data using the third AI model based on the determining of the one or more upcoming additional tasks. Further, the communication device 1002 may be further configured for transmitting the upcoming task data to each of the one or more first entity devices and the one or more second entity devices.

Further, in some embodiments, the one or more AI models further may include a fourth artificial intelligence (AI) model. Further, the communication device 1002 may be further configured for receiving a valuation request data from the one or more first entity devices. Further, the valuation request data represents one or more requests from the one or more first entities for valuating one or more real estate properties associated with the one or more real estate transactions. Further, the communication device 1002 may be further configured for transmitting a valuation to the one or more first entity devices. Further, the processing device 1004 may be further configured for analyzing the document data using the fourth AI model based on the one or more requests. Further, the processing device 1004 may be further configured for identifying one or more characteristics of the one or more real estate properties using the fourth AI model based on the analyzing of the document data. Further, the processing device 1004 may be further configured for determining the valuation for the one or more real estate properties based on the identifying of the one or more characteristics.

In some embodiments, the completion status includes one or more of a complete status and an incomplete status. Further, the processing device 1004 may be further configured for generating a rectification data based on the determining of the completion status comprising the incomplete status. Further, the rectification data represents one or more rectification detail relatives to the one or more tasks.

Further, in some embodiments, the one or more AI models further may include a fifth artificial intelligence (AI) model. Further, the communication device 1002 may be further configured for receiving a property assessment request data from the one or more first entity devices. Further, the property assessment request data represents one or more second requests from the one or more first entities for assessing one or more real estate properties associated with the one or more real estate transactions. Further, the communication device 1002 may be further configured for transmitting an assessment report to the one or more first entity devices. Further, the processing device 1004 may be further configured for analyzing the document data using the fifth AI model based on the one or more second requests. Further, the processing device 1004 may be further configured for generating the assessment report for the one or more real estate properties using the fifth AI model based on the analyzing of the document data.

In some embodiments, the one or more tasks include one or more of a contingency management task and a document signing task.

In some embodiments, each of the one or more first entities and the one or more second entities include one or more of one or more real estate buyers, one or more real estate sellers, one or more real estate agents, and an escrow officer.

In some embodiments, the one or more real estate documents include one or more of a buyer information, a seller information, an agent information, an escrow officer information, a title information, one or more inspection reports, one or more contingencies, a check box status, one or more signatures, initials, a signing ceremony information, one or more important dates, a purchase price information, and one or more special terms associated with the one or more real estate transactions.

In some embodiments, the transmitting of the notification data to the one or more second entity devices includes transmitting the notification data using one or more of an internet-standard protocol and a short message service protocol.

In some embodiments, the one or more real estate documents include one or more of a heterogeneous document, a semi-structured document, and an unstructured document.

In some embodiments, the verifying of the one or more real estate documents includes identifying a cryptographic proof associated with the one or more real estate documents. Further, the cryptographic proof demonstrates a validity of the one or more real estate documents without exposing the one or more contents of the one or more real estate documents.

In some embodiments, the second AI model includes a knowledge graph constructed using at least one embedding generated by a large language model (LLM) from two or more regional statues.

In some embodiments, the one or more characteristics include one or more of a local price trend information, one or more recent sale information, one or more upcoming architecture information, and a migration trend information associated with the one or more real estate properties.

In some embodiments, the one or more regulatory queries include one or more application programming interface (API) calls representing a request to one or more APIS associated with the one or more regulatory databases.

Although the invention has been explained in relation to its preferred embodiment, it is to be understood that many other possible modifications and variations can be made without departing from the spirit and scope of the invention as hereinafter claimed.

What is claimed is:

1. A method for facilitating management of real estate transactions, the method comprising:
receiving, using a communication device, a document data from at least one first entity device associated with at least one first entity, wherein the document data represents at least one real estate document associated with at least one real estate transaction;
receiving, using the communication device, a task data from the at least one first entity device, wherein the task data represents at least one task associated with the at least one real estate document relative to the at least one real estate transaction;
analyzing, using a processing device, each of the document data and the task data using at least one artificial intelligence (AI) model;
determining, using the processing device, a completion status for the at least one real estate transaction using the at least one AI model based on the analyzing of each of the document data and the task data;
generating, using the processing device, a notification data based on the determining of the completion status, wherein the notification data represents at least one notification informing at least one second entity of completion status; and
transmitting, using the communication device, the notification data to at least one second entity device associated with the at least one second entity.

2. The method of claim 1 further comprising:
determining, using the processing device, at least one regulatory requirement associated with the at least one real estate transaction based on the analyzing of each of the document data and the task data;
obtaining, using the processing device, a regulatory data based on the determining of the at least one regulatory requirement, wherein the regulatory data represents at least one regulatory detail associated with the at least one real estate transaction; and
analyzing, using the processing device, the regulatory data using the at least one AI model, wherein the determining of the completion status is further based on the analyzing of the regulatory data.

3. The method of claim 2 further comprising:
generating, using the processing device, at least one regulatory query based on the determining of the at least one regulatory requirement;
transmitting, using the communication device, the at least one regulatory query to at least one regulatory database device associated with at least one regulatory database of at least one regulatory body; and
receiving, using the communication device, the regulatory data from the at least one regulatory database device, wherein the obtaining of the regulatory data is further based on the receiving of the regulatory data.

4. The method of claim 1, wherein the at least one AI model is an optical character recognition-enabled large language (OCR-LLM) model.

5. The method of claim 1 further comprising verifying, using the processing device, the at least one real estate document using a zero-knowledge proof, wherein the zero-knowledge proof enables a validation of at least one of an authenticity and an integrity of the at least one real estate document without revealing at least one content of the at least one real estate document, wherein the analyzing of each of the document data and the task data is further based on the verifying of the at least one real estate document.

6. The method of claim 3, wherein the at least one AI model comprises a second artificial intelligence (AI) model, wherein the method further comprises:
determining, using the processing device, at least one jurisdiction associated with the at least one real estate transaction using the second AI model based on the analyzing of each of the document data and the task data; and
identifying, using the processing device, the at least one regulatory body associated with the at least one jurisdiction based on the determining of the at least one jurisdiction, wherein the transmitting of the at least one regulatory query to the at least one regulatory database device associated with the at least one regulatory database of the at least one regulatory body is further based on the identifying of the at least one regulatory body.

7. The method of claim 1, wherein the at least one AI model further comprises a third artificial intelligence (AI) model, wherein the method further comprises:
determining, using the processing device, at least one upcoming additional task associated with the at least one real estate transaction using the third AI model based on the analyzing of each of the document data and the task data;
generating, using the processing device, an upcoming task data using the third AI model based on the determining of the at least one upcoming additional task; and
transmitting, using the communication device, the upcoming task data to each of the at least one first entity device and the at least one second entity device.

8. The method of claim 1, wherein the at least one AI model further comprises a fourth artificial intelligence (AI) model, wherein the method further comprises:
receiving, using the communication device, a valuation request data from the at least one first entity device, wherein the valuation request data represents at least one request from the at least one first entity for valuating at least one real estate property associated with the at least one real estate transaction;
analyzing, using the processing device, the document data using the fourth AI model based on the at least one request;
identifying, using the processing device, at least one characteristic of the at least one real estate property using the fourth AI model based on the analyzing of the document data;
determining, using the processing device, a valuation for the at least one real estate property based on the identifying of the at least one characteristic; and
transmitting, using the communication device, the valuation to the at least one first entity device.

9. The method of claim 1, wherein the completion status comprises at least one of a complete status and an incomplete status, wherein the method further comprises generating, using the processing device, a rectification data based on the determining of the completion status comprising the incomplete status, wherein the rectification data represents at least one rectification detail relative to the at least one task.

10. The method of claim 1, wherein the at least one AI model further comprises a fifth artificial intelligence (AI) model, wherein the method further comprises:
receiving, using the communication device, a property assessment request data from the at least one first entity device, wherein the property assessment request data represents at least one second request from the at least one first entity for assessing at least one real estate property associated with the at least one real estate transaction;
analyzing, using the processing device, the document data using the fifth AI model based on the at least one second request;
generating, using the processing device, an assessment report for the at least one real estate property using the fifth AI model based on the analyzing of the document data; and
transmitting, using the communication device, the assessment report to the at least one first entity device.

11. A system for facilitating management of real estate transactions, the system comprising:
a communication device configured for:
receiving a document data from at least one first entity device associated with at least one first entity, wherein the document data represents at least one real estate document associated with at least one real estate transaction;
receiving a task data from the at least one first entity device, wherein the task data represents at least one task associated with the at least one real estate document relative to the at least one real estate transaction; and
transmitting a notification data to at least one second entity device associated with at least one second entity; and
a processing device communicatively coupled with the communication device, wherein the processing device is configured for:
analyzing each of the document data and the task data using at least one artificial intelligence (AI) model;
determining a completion status for the at least one real estate transaction using the at least one AI model based on the analyzing of each of the document data and the task data; and
generating the notification data based on the determining of the completion status, wherein the notification data represents at least one notification informing the at least one second entity of completion status.

12. The system of claim 11, wherein the processing device is further configured for:
determining at least one regulatory requirement associated with the at least one real estate transaction based on the analyzing of each of the document data and the task data;
obtaining a regulatory data based on the determining of the at least one regulatory requirement, wherein the regulatory data represents at least one regulatory detail associated with the at least one real estate transaction; and
analyzing the regulatory data using the at least one AI model, wherein the determining of the completion status is further based on the analyzing of the regulatory data.

13. The system of claim 12, wherein the processing device is further configured for generating at least one regulatory query based on the determining of the at least one regulatory requirement, wherein the communication device is further configured for:
transmitting the at least one regulatory query to at least one regulatory database device associated with at least one regulatory database of at least one regulatory body; and
receiving the regulatory data from the at least one regulatory database device, wherein the obtaining of the regulatory data is further based on the receiving of the regulatory data.

14. The system of claim 11, wherein the at least one AI model is an optical character recognition-enabled large language (OCR-LLM) model.

15. The system of claim 11, wherein the processing device is further configured for verifying the at least one real estate document using a zero-knowledge proof, wherein the zero-knowledge proof enables a validation of at least one of an authenticity and an integrity of the at least one real estate document without revealing at least one content of the at least one real estate document, wherein the analyzing of each of the document data and the task data is further based on the verifying of the at least one real estate document.

16. The system of claim 13, wherein the at least one AI model comprises a second artificial intelligence (AI) model, wherein the processing device is further configured for:
determining at least one jurisdiction associated with the at least one real estate transaction using the second AI model based on the analyzing of each of the document data and the task data; and
identifying the at least one regulatory body associated with the at least one jurisdiction based on the determining of the at least one jurisdiction, wherein the transmitting of the at least one regulatory query to the at least one regulatory database device associated with the at least one regulatory database of the at least one regulatory body is further based on the identifying of the at least one regulatory body.

17. The system of claim 11, wherein the at least one AI model further comprises a third artificial intelligence (AI) model, wherein the processing device is further configured for:
determining at least one upcoming additional task associated with the at least one real estate transaction using the third AI model based on the analyzing of each of the document data and the task data; and
generating an upcoming task data using the third AI model based on the determining of the at least one upcoming additional task, wherein the communication device is further configured for transmitting the upcoming task data to each of the at least one first entity device and the at least one second entity device.

18. The system of claim 11, wherein the at least one AI model further comprises a fourth artificial intelligence (AI) model, wherein the communication device is further configured for:
receiving a valuation request data from the at least one first entity device, wherein the valuation request data represents at least one request from the at least one first entity for valuating at least one real estate property associated with the at least one real estate transaction; and
transmitting a valuation to the at least one first entity device, wherein the processing device is further configured for:
analyzing the document data using the fourth AI model based on the at least one request;
identifying at least one characteristic of the at least one real estate property using the fourth AI model based on the analyzing of the document data; and
determining the valuation for the at least one real estate property based on the identifying of the at least one characteristic.

19. The system of claim 11, wherein the completion status comprises at least one of a complete status and an incomplete status, wherein the processing device is further configured for generating a rectification data based on the determining of the completion status comprising the incomplete status, wherein the rectification data represents at least one rectification detail relative to the at least one task.

20. The system of claim 11, wherein the at least one AI model further comprises a fifth artificial intelligence (AI) model, wherein the communication device is further configured for:
receiving a property assessment request data from the at least one first entity device, wherein the property assessment request data represents at least one second request from the at least one first entity for assessing at least one real estate property associated with the at least one real estate transaction; and
transmitting an assessment report to the at least one first entity device, wherein the processing device is further configured for:
analyzing the document data using the fifth AI model based on the at least one second request; and
generating the assessment report for the at least one real estate property using the fifth AI model based on the analyzing of the document data.
